(19) United States
(12) Patent Application Publication
(10) Pub. No.: US 2023/0079735 A1
(43) Pub. Date: Mar. 16, 2023

(54) ELECTRODE MATERIAL INCLUDING SURFACE MODIFIED SILICON OXIDE PARTICLES

(71) Applicant: NANOGRAF CORPORATION, Chicago, IL (US)

(72) Inventors: Seonbaek HA, Chicago, IL (US); Cary Michael HAYNER, Chicago, IL (US); Kathryn HICKS, Chicago, IL (US); In KIM, Chicago, IL (US); Nevin NAREN, Chicago, IL (US); Aaron YOST, Evanston, IL (US)

(21) Appl. No.: 17/822,958

(22) Filed: Aug. 29, 2022

Related U.S. Application Data
(60) Provisional application No. 63/244,357, filed on Sep. 15, 2021.

(51) Int. Cl. H01M 4/36; H01M 10/0525; H01M 50/46; H01M 4/04; H01M 4/505; H01M 4/58; H01M 4/583; H01M 4/62

(52) U.S. Cl. CPC H01M 4/366; H01M 10/0525; H01M 50/46; H01M 4/0471; H01M 4/505; H01M 4/5825; H01M 4/583; H01M 4/623; H01M 2004/021

(57) ABSTRACT

An active material for a lithium ion secondary battery includes core particles containing SiO or M-SiO materials where M is selected from Al, Cu, Fe, K, Li, Mg, Na, Ni, Sn, Ti, Zn, Zr, or any combination thereof, and an amorphous Group 13 or Group 15 material (“G13/G15 material”) comprising at least one element selected from boron (B), aluminum (Al), gallium (Ga), indium (In), thallium (Tl), nitrogen (N), phosphorus (P), arsenic (As), antimony (Sb), or bismuth (Bi), coated on the core particles.

### TECHNICAL FIELD

Aspects of the present disclosure relate to electrode materials including surface modified silicon oxide particles, and in particular, to anodes including the electrode materials, and lithium ion batteries including the anodes.

### BACKGROUND

Lithium (Li) ion electrochemical cells typically require materials that enable high energy density, high power density and high cycling stability. Li ion cells are commonly used in a variety of applications, which include consumer electronics, wearable computing devices, military mobile equipment, satellite communication, spacecraft devices and electric vehicles, and are particularly popular for use in large-scale energy applications such as low-emission electric vehicles, renewable power plants, and stationary electric grids. Additionally, lithium-ion cells are at the forefront of new generation wireless and portable communication applications. One or more lithium ion cells may be used to configure a battery that serves as the power source for any of these applications. It is the explosion in the number of higher energy demanding applications, however, that is accelerating research for yet even higher energy density, higher power density, higher-rate charge-discharge capability, and longer cycle life lithium ion cells. Additionally, with the increasing adoption of lithium-ion technology, there is an ever increasing need to extend today's energy and power densities, as applications migrate to higher current needs, longer run-times, wider and higher power ranges and smaller form factors.

Active anode materials such as silicon are a desirable replacement for current graphite based anodes due to their high lithium storage capacity that can exceed 7× that of graphite (up to 3200 mAh/g). However, due to the large volume expansion of alloy particles upon lithiation, these anode materials typically exhibit extremely poor cycle life due to mechanical stress, low coulombic efficiency and electrical disconnection.

Accordingly, there is a need for an advanced anode material for use in an electrochemical cell that includes an improved silicon oxide active material.

### SUMMARY

According to an embodiment of the present disclosure, an active material for a lithium ion secondary battery includes core particles containing SiOₓ or M-SiOₓ, where 0<x<1.2, and M is selected from Al, Ca, Cu, Fe, K, Li, Mg, Na, Ni, Sn, Ti, Zn, Zr, or any combination thereof, a coating of an amorphous G13/G15 material comprising at least one element selected from boron (B), aluminum (Al), gallium (Ga), indium (In), thallium (Tl), nitrogen (N), phosphorus (P), arsenic (As), antimony (Sb), or bismuth (Bi) on the core particles, and at least one of boron or phosphorus diffused into the core particles.

In one embodiment, the G13/15 material, such as at least one of boron or phosphorus is diffused only into a surface region of the core particles to a depth of up to about 20 nm. In another embodiment an electrode material for the lithium ion secondary battery includes the active material and a binder. In another embodiment, a lithium ion secondary battery includes a cathode electrode, an electrolyte, and an anode electrode comprising the electrode material comprising from about 15 wt % to about 25 wt % of the binder, from about 2 wt % to about 7 wt % of a conductive additive; and from about 70 wt % to about 80 wt % of the active material.

In another embodiment, a method of forming an active material for a lithium ion secondary battery comprises mixing from about 1 wt % to about 7 wt % of precursor material comprising at least one of boron or phosphorus with from about 90 wt % to about 95 wt % of SiOₓ or M-SiOₓ core particles, wherein 0<x<1.2, and M is selected from Li, Na, Mg, Cu, Ni, Zn, Fe, or any combination thereof, to coat the core particles with the precursor material; and sintering the coated core particles in an inert atmosphere to form active material particles comprising the core particles and a coating of an amorphous G13/G15 material on the core particles, and to diffuse at least one of boron or phosphorus from the precursor material into the core particles.

### BRIEF DESCRIPTION OF THE DRAWINGS

FIG. 1A is a sectional diagram of an active material particle 100, according to various embodiments of the present disclosure.

FIG. 1B is a sectional diagram showing a modified active material particle 100A, according to various embodiments of the present disclosure.

FIG. 1C is a sectional diagram showing a composite active material particle, according to various embodiments of the present disclosure.

FIG. 1D is a sectional diagram showing a composite active material particle, according to various embodiments of the present disclosure.

FIG. 1E is a sectional diagram of a core particle, according to various embodiments of the present disclosure.

FIG. 1F is a sectional diagram of a core particle, according to various embodiments of the present disclosure.

FIGS. 2A, 2B, and 2C illustrate Raman spectra for graphite and various graphene-based materials.

FIG. 3 is a bar chart comparing the Raman spectra I_{D}/I_{G} ratios of typical carbon materials to low-defect turbostratic carbon.

FIGS. 4A, 4B, and 4C illustrate the Raman spectra of electrode active materials comprising SiOₓ core particles respectively encapsulated by amorphous carbon, reduced graphene oxide (rGO), and low-defect turbostratic carbon.

FIG. 5 is a graph showing anode capacity retention as a function of number cycles of exemplary and comparative half-cells.

FIG. 6 is a graph showing the pH of exemplary and comparative active materials as a function of time.

FIG. 7A is a graph showing X-ray diffraction (XRD) results for the exemplary active material, as compared to the control active material and to crystalline Li₂B₄O₇ material.

FIG. 7B is a graph showing XRD data for the exemplary active material and crystalline B₄C material.

FIG. 8A is a graph showing capacity retention of half cells including anodes that include the exemplary active material, carbon black, and a PAA binder, at a 75:5:20 weight ratio, and comparative half cells that include anodes that includes a comparative active material including Si nanoparticles and the CSS, carbon black, and a PAA binder, at a 75:5:20 weight ratio.

FIG. 8B is a graph showing XRD results for the exemplary and comparative active materials.

### DETAILED DESCRIPTION OF THE PREFERRED EMBODIMENTS

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention. It will also be understood that the term “about” may refer to a minor measurement errors of, for example, +/−5% to 10%.

Words such as “thereafter,” “then,” “next,” etc. are not necessarily intended to limit the order of the steps; these words may be used to guide the reader through the description of the methods. Further, any reference to claim elements in the singular, for example, using the articles “a,” “an” or “the” is not to be construed as limiting the element to the singular.

An “electrode material” is defined as a material that may be configured for use as an electrode within an electrochemical cell, such as a lithium ion rechargeable battery. An “electrode” is defined as either an anode or a cathode of an electrochemical cell. A “composite electrode material” is also defined to include active material particles combined with one of particles, flakes, spheres, platelets, sheets, tubes, fibers, or combinations thereof and that are of an electrically conductive material. The particles, flakes, spheres, platelets, sheets, tubes, fibers or combinations thereof may further be one of flat, crumpled, wrinkled, layered, woven, braided, or combinations thereof.

The electrically conductive material, may be selected from the group consisting of an electrically conductive carbon-based material, an electrically conductive polymer, graphite, a metallic powder, nickel, aluminum, titanium, stainless steel, and any combination thereof. The electrically conductive carbon-based material may further include one of graphite, graphene, diamond, pyrolytic graphite, carbon black, low defect turbostratic carbon, fullerenes, other carbonaceous materials, or combinations thereof. Herein, other carbonaceous materials may include pyrolyzed carbon materials. Pyrolyzed carbon may be derived from carbonaceous precursor materials, for example: hydrocarbons such as pitch or tar; citric acid; polysaccharides such as sucrose, glucose, or chitosan; polymers such as polyvinyl alcohol (PVA), polyvinylpyrrolidone (PVP), polyacrylic acid (PAA), polydopamine (PDA) or polyacrylonitrile (PAN); combinations thereof; or the like. An “electrode material mixture” is defined as a combination of materials such as: material particles (either electrochemically active, electrically conductive, composite or combinations thereof), a binder or binders, a non-crosslinking and/or a crosslinking polymer or polymers, which are mixed together for use in forming an electrode for an electrochemical cell. An “electrochemically active material”, “electrode active material” or “active material” is defined herein as a material that inserts and releases ions such as ions in an electrolyte, to store and release an electrical potential. The term “inserts and releases” may be further understood as ions that intercalate and deintercalate, or lithiate and delithiate. The process of inserting and releasing of ions is also understood, therefore, to be intercalation and deintercalation, or lithiation and delithiation. An “active material” or an “electrochemically active material” or an “active material particle”, therefore, is defined as a material or particle capable of repeating ion intercalation and deintercalation or lithium lithiation and delithiation.

As defined herein a secondary electrochemical cell is an electrochemical cell or battery that is rechargeable. “Capacity” is defined herein as a measure of charge stored by a battery as determined by the mass of active material contained within the battery, representing the maximum amount of energy, in ampere-hours (Ah), which can be extracted from a battery at a rated voltage. Capacity may also be defined by the equation: capacity=energy/voltage or current (A) x time (h). “Energy” is mathematically defined by the equation: energy=capacity (Ah) x voltage (V). “Specific capacity” is defined herein as the amount of electric charge that can be delivered for a specified amount of time per unit of mass or unit of volume of active electrode material. Specific capacity may be measured in gravimetric units, for example, (Ah)/g or volumetric units, for example, (Ah)/cc. Specific capacity is defined by the mathematical equation: specific capacity (Ah/kg)=capacity (Ah)/mass (kg). “Rate capability” is the ability of an electrochemical cell to receive or deliver an amount of energy within a specified time period. Alternately, “rate capability” is the maximum continuous or pulsed energy a battery can provide per unit of time.

“C-rate” is defined herein as a measure of the rate at which a battery is discharged relative to its maximum nominal capacity. For example, a 1C current rate means that the discharge current will discharge the entire battery in 1 hour; a C/2 current rate will completely discharge the cell in 2 hours and a 2C rate in 0.5 hours. “Power” is defined as the time rate of energy transfer, measured in Watts (W). Power is the product of the voltage (V) across a battery or cell and the current (A) through the battery or cell. “C-Rate” is mathematically defined as C-Rate (inverse hours)=current (A)/capacity (Ah) or C-Rate (inverse hours)=1/discharge time (h). Power is defined by the mathematical equations: power (W)=energy (Wh)/time (h) or power (W)=current (A) x voltage (V). Coulombic efficiency is the efficiency at which charge is transferred within an electrochemical cell. Coulombic efficiency is the ratio of the output of charge by a battery to the input of charge.

Considerable development in both commercial and academic settings has been focused on designing systems that minimize or accommodate total volume swelling of alloy particles and associated electrochemical losses. This has typically been approached on two fronts. At the particle level, designing particle architectures that confine swelling to small domains to prevent particle fracture and electrical disconnection, and at the electrode level, designing a polymer matrix and conductive network that can accommodate the volume swell of the lithium storing materials while retaining mechanical and electronic integrity during repeated charge/discharge operation of the Li-ion cell.

A popular technique to stabilize the cycle life of alloy active anode materials such as silicon is through the mixture, encapsulation or other incorporation by various carbon materials to provide an electronically conducting surface and facilitate general electronic conduction throughout the electrode particle network. These include CVD amorphous carbon coatings, graphene wrappings, and physical mixing with graphite, conductive carbons, and carbon nanoplatelets. However, active materials may still swell due to their rigid nature and lack of long range order, and particles may still become isolated resulting in storage capacity loss and trapped lithium.

Various embodiments of the present disclosure provide an anode material for Li-ion batteries that includes silicon oxide particles and an amorphous material comprising at least one of boron or phosphorus (“B/P material”) coated on the core particles and diffused into the core particles that increases cycle life stability of the anode material.

Silicon Oxide Materials

Silicon may significantly increase cell capacity when incorporated within an electrode of an electrochemical cell. Silicon and silicon oxide are often incorporated within an electrode comprising graphite, graphene, or other carbon-based active materials. Examples of electrodes comprising carbon-based materials and silicon are provided in U.S. Pat. Nos. 8,551,650, 8,778,538, and 9,728,773 to Kung et al., and U.S. Pat. Nos. 10,135,059 and 10,135,063 to Huang et al., all the contents of which are fully incorporated herein by reference.

Herein, “SiO materials” may generally refer to silicon and oxygen-containing materials. SiO materials are of interest for use in anode electrodes of lithium-ion batteries, due to having high theoretical energy and power densities. However, the utilization of current commercial SiO materials, such as silicon oxide (e.g., SiOₓ, wherein x ranges from 0.8 to 1.2, such as from 0.9 to 1.1) has been limited due to having a low 1^{st} cycle efficiency and a high irreversibility. This low 1^{st} cycle efficiency is due to high irreversible Li⁺ reaction with the silicon oxide matrix.

In order to decrease the irreversible Li⁺ reaction with SiO materials, various embodiments include metalized (e.g., metal doped) silicon oxide materials (M-SiO). Herein, M-SiO materials refer to active materials are directly reacted with metal-containing precursors, such as lithium-containing precursors and/or magnesium-containing precursors, to form metalized silicon oxide phases, prior to being utilized in a battery as an active material and/or undergoing charge and discharge reactions. In other words, the metalizing metal, remains in the active material and does not intercalate or deintercalate during battery charging and discharging. In some embodiments, the battery may be a lithium-ion secondary battery, such as a solid-state lithium-ion battery comprising a solid-state anode, a solid-state cathode, and a solid-state electrolyte.

In some embodiments, the embodiment silicon oxide materials may include M-SiO that are metalized to include (i.e., doped with) metals such as Al, Ca, Cu, Fe, K, Li, Mg, Na, Ni, Sn, Ti, Zn, Zr, or any combination thereof. Preferably, the M-SiO materials may comprise lithium-doped (i.e., lithium metalized) SiO (Li—SiO) materials and/or Mg-doped (i.e., Mg metallized) SiO (Mg—SiO) materials.

Electrode materials including M-SiO active materials have been found to provide increased 1st cycle efficiency (FCE), as compared to non-metalized SiO materials. Unfortunately, some M-SiO materials have been found to suffer from particle fracture, severe electrical disconnection, and rapid capacity loss, often leading to more than 90% capacity fade within 20 cycles.

Coating M-SiO materials with carbon and/or other materials, and/or blending M-SiO materials with graphite have been found to slightly reduce the electrical disconnection and capacity loss of active materials, delaying the over 50% capacity fade to ˜50 cycles, which is still highly unsatisfactory cycling stability for commercial applications. Overall, current M-SiO materials do not exhibit electrical stability sufficient for commercialization.

In addition, many conventional M-SiO materials, such as Li—SiOₓ materials, wherein x ranges from 0.8 to 1.2, such as from 0.9 to 1.1, are not chemically stable. Impurities such as Li₂CO₃, LiOH, LiHCO₃, etc., can be found on the surface of Li—SiO anode materials after synthesis. Surface impurities can come from different sources, such as unreacted lithium during the sintering of lithium source precursors with the hydroxide precursors, ion-exchange with moisture, and further reaction with CO₂ during storage. These impurities may cause problems such as gelation of the slurries required for electrode coating, gassing during Li-ion cell storage, shortened cycle-life, etc. In addition, active Si nanoparticles and SiO-type materials are not stable when used in a high-pH environment, which limits some of the electrode or slurry coating procedures available. In particular, a high pH may accelerate the dissolution of silicate species in the glass matrix of SiO materials when it is exposed to the water. Conventional CVD-carbon coating does not prevent this problem.

The high pH of Li—SiO materials may be of particular concern when used in lithium ion cells including cathode materials having a high nickel content. High nickel content positive electrode materials are usually processed in a dry room to minimize the formation of surface impurities during the storage, while a “finishing” process is often used to eliminate surface impurities after synthesis.

Accordingly, there is a need for improved M-SiO materials that provide increased cycle-life, and improved high pH stability. According to various embodiments, silicon oxide active materials include an inorganic surface modification, coating and/or dopant that can stabilize SiO materials.

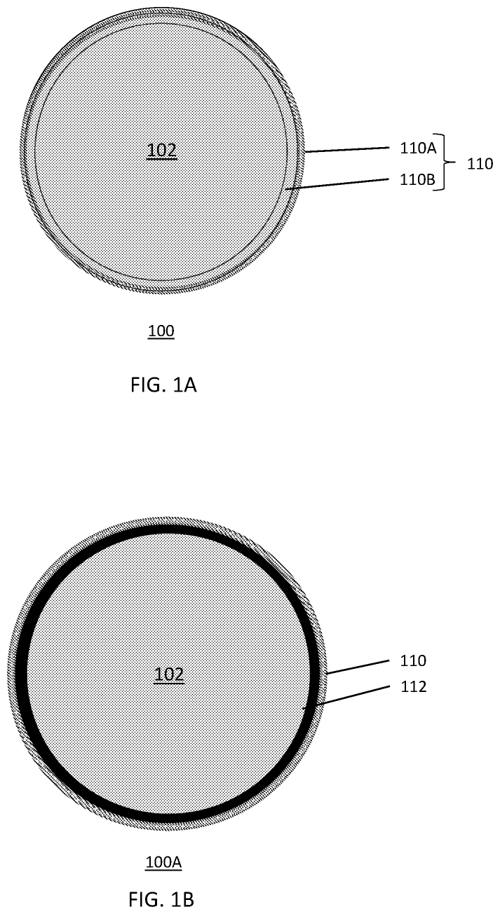

FIG. 1A is a sectional diagram of an active material particle 100, according to various embodiments of the present disclosure. Referring to FIG. 1A, in various embodiments, the active material 100 may include a core particle 102 and a chemical stability structure (CSS) 110 configured to increase the usable cycle life of the core particle 102. The core particle 102 may include M-SiO materials that include metalized silicon species and silicon (e.g., crystalline and/or amorphous silicon). The metalized silicon species may include metalized silicides and metalized silicates. In some embodiments, the M-SiO materials may also include silicon oxide (SiOₓ, wherein x ranges from 0.8 to 1.2, such as from 0.9 to 1.1). In various embodiments, the M-SiO materials may include lithiated silicon species. Herein, “lithiated silicon species” may include lithium silicides (LiₓSi, 0<x<4.4), and/or one or more lithium silicates (Li₂Si₂O₅, Li₂SiO₃, and/or Li₄SiO₄, etc.).

The active material particles 100 may have an average particle size that ranges from about 500 nm to about 20 μm, such as from about 1 μm to about 20 μm, from about 1 μm to about 10 μm, from about 3 μm to about 7 μm, or about 5 μm. The active material particles 100 may have a surface area that ranges from about 0.5 m²/g to about 30 m²/g, such as from about 1 m²/g to about 20 m²/g, including from about 1.5 m²/g to about 15 m²/g.

Chemical Stability Structures

In various embodiments, the CSS 110 may provide unexpected chemical stability to the core particle 102, during cycling in an electrochemical cell. The usable cycle life of an electrochemical cell may be defined as the number of cycles (Cycle n) that the cell can cycle while maintaining a capacity that is at least 80% of its initial capacity (i.e. cycle 1 capacity).

The CSS 110 may include a material that includes one or more elements selected from Group 13 (e.g., boron (B), aluminum (Al), gallium (Ga), indium (In), and thallium (Tl)) and/or one or more elements selected from Group 15 (e.g., nitrogen (N), phosphorus (P), arsenic (As), antimony (Sb), and bismuth (Bi)), which may be referred to herein as a “G13/G15 material”. In some embodiments, the G13/G15 material may include a boron and/or phosphorus-containing material, which may be referred to herein as a “B/P material”. For example, the B/P material may include boron compounds, such as boron oxides (e.g., boron trioxide, B₂O₃) and borates (e.g., lithium borate), borosilicates, and/or lithium borosilicates, and/or phosphate compounds, such as lithium phosphates, silicate phosphates, phosphorus oxides, and/or lithium silicate phosphates. For example, suitable boron compounds may include boron trioxide (B₂O₃), lithium metaborate (LiBO₂), lithium tetraborate (Li₂B₄O₇), tri-lithium borate (Li₃BO₃), lithium borosilicate (B₂O₃—SiO₂—Li₂Si₂O₅, B₂O₃—SiO₂—Li₂O, B₂O₃—SiO₂—Li₂SiO₃, B₂O₃—SiO₂—Li₄SiO₄, or B₂O₃—SiO₂—Li₂Si₂O₅), borosilicate (B₂O₃—SiO₂), and/or borosilicate in combination with Li₂SiO₃, Li₄SiO₄, and/or Li₂Si₂O₅. Suitable phosphorus compounds may include phosphate (P₂O₅) lithium phosphate (Li₃PO₄), lithium silicate-lithium phosphate (xLi₄SiO₄-(1-x)Li₃PO₄), xLi₂SiO₃-(1-x)Li₃PO₄, xLi₂Si₂O₅-(1-x)Li₃PO₄, lithium aluminum borate, lithium borosilicate, lithium phosphosilicate, combinations thereof, or the like. In some embodiments, the CSS 110 may include lithium aluminum borosilicate, lithium zirconium borosilicate, lithium niobate borosilicate, combinations thereof, or the like.

However, other boron and/or phosphorus compounds are within the scope of the present disclosure. For example, in some embodiments, the CSS 110 may include a G13/G15 material that also contains Group 1 elements (e.g., Li, Na, K, Rb, Cs), Group 2 elements (e.g., Be, Mg, Ca, Sr, Ba), and/or Group 4 elements (E.g., Ti, Zr, Hf, Rf) of the periodic table of elements. For example, the G13/G15 material may include aluminum borosilicate, lithium zirconium borosilicate, lithium niobate borosilicate, or the like. In other embodiments, the CSS 110 may include Group 13 (e.g., B, Al, Ga, In, Ti) compounds that may also include Group 1 elements (e.g., Li, Na, K, Rb, Cs) and/or Group 2 elements (e.g., Be, Mg, Ca, Sr, Ba).

In some embodiments, during CSS 110 formation, the G13/G15 material may react with a native oxide layer on the core particles. For example, the G13/G15 material may comprise BₓO_{y}, xLi₂O-yB₂O₃, xSiO₂-yB₂O₃, and/or xLi₂O-ySiO₂-zB₂O₃ (0<x≤2, 0<y≤3, 0<z≤3). The CSS 110 may include, consist of, or consist essentially of amorphous materials. In some embodiments, the CSS 110 may be free or essentially of crystalline species and/or phases. For example, the CSS 110 may include less than 5 wt % (e.g., 0 to 5 wt %), such as less than 3 wt %, less than 1 wt %, less than 0.5 wt %, or less than 0.25 wt % crystalline G13/G15 materials. In various embodiments, the CSS 110 and/or the G13/G15 material may comprise from about 0.1 wt % to about 10 wt %, such as from about 1 wt % to about 4 wt %, from about 1.25 wt % to about 2.5 wt %, or from about 1.5 wt % to about 2.0 wt %, of the total weight of the active material particles 100, and the silicon oxide material of the core particles 102 may comprise from about 95 wt % to about 99.9 wt %, such as from about 97.5 wt % to about 99 wt %, or from about 98 wt % to about 98.5 wt % of the total weight of the active material particles 100.

In some embodiments, the CSS 110 may include a continuous or discontinuous, amorphous coating 110A including the G13/G15 material and formed on the surface of the core particle 102. The coating 110A may cover from about 60% to about 100% of the surface area of the core particle 102, such as from about 60% to 99%, or from about 61% to about 80% of the surface of the core particle 102. The coating 110A may have an average thickness of from about 0.5 to about 500 nm, such as from about 0.75 to about 100 nm, or from about 1 nm to about 50 nm. The G13/G15 material or the coating 110A may be at least 50 atomic percent (at %), such as at least 90 at %, at least 95 at %, at least 97 at %, at least 99 at %, at least 99.5 at %, or at least 99.75 at % amorphous.

The coating 110A may include at least 60 wt % of at least one G13/G15 material, such as a G13/G15 material comprising of boron or phosphorus. For example, the coating 110A may include from about 60 to about 80 wt % B or P, such as from about 61 to about 70 wt % P or B.

In various embodiments, the CSS 110 may include G13/G15 materials that include dopants, such as boron and/or phosphorus, which may optionally diffuse into the core particle 102 to form an optional diffusion layer 110B within the silicon oxide material of the core particle 102. The diffusion layer 110B may include the silicon oxide material and a relatively small amount of the G13/G15 material, such as boron or phosphorus (e.g., less than 5 wt % of boron and/or phosphorus) that diffuses into the core particle 102 to form a G13/G15 material doped silicon oxide layer 110B, such as boron and/or phosphorus doped silicon oxide layer 110B. Preferably, the majority of the G13/G15 material may remain in the coating 110A, on the surface of the core particle 102. For example, from about 0.1 atomic % to about 5 atomic % of the G13/G15 material, such as from about 1 wt % to about 5 wt % of the G13/G15 material, may diffuse into the diffusion layer 110B of the core particle 102, and the coating 110A may include from about 95 to about 99 atomic % of the G13/G15 material, based on a total amount of the G13/G15 material included in the active material particle 100.

The diffusion layer 110B may have a thickness ranging from 0 to about 100 nm, such as from about 10 to about 50 nm, or from about 15 to about 30 nm. In other words, the thickness of the diffusion layer 110B may be equal to a maximum diffusion depth of the G13/G15 material.

According to various embodiments, active material particles may be prepared by mixing core particles comprising the SiO material or the M-SiO material with a G13/G15 material precursor. The core particles may have a particle size as described above with respect to FIG. 1A.

Suitable G13/G15 material precursors may include boric acid (H₃BO₃), metaboric acid (HBO₂), boron trioxide (B₂O₃), trihydroxy boroxine (B₃H₃O₆), lithium metaborate (LiBO₂), lithium tetraborate (Li₂B₄O₇), tri-lithium borate (Li₃BO₃), lithium borosilicate (B₂O₃—SiO₂—Li₂Si₂O₅, B₂O₃—SiO₂—Li₂O) borosilicate (B₂O₃—SiO₂), borate salts, phosphate salts, combinations thereof, or the like.

The mixture may include from about 90 wt % to about 99 wt %, such as from about 95 wt % to about 98.5 wt %, from about 97 wt % to about 98 wt %, or about 97.5 wt % silicon oxide particles, based on the total weight of the mixture. The mixture may also include from about 1 wt % to about 90 wt %, such as from about 5 wt % to about 2.5 wt %, from about 3 wt % to about 2 wt %, or about 2.5 wt %, of the G13/G15 material precursors, based on the total weight of the mixture.

The mixture may be gently mixed in any suitable low-shear mixing process, such as mixing in a planetary mixer, for a time period ranging from about 5 minutes to about 25 minutes, such as from about 8 minutes to about 15 minutes, or about 10 minutes. In some embodiments, high-shear mixing processes, such as ball milling or the like, may be avoided in order to avoid damaging the active material particles. For example, ball milling may fracture silicon oxide material particles, which may reduce the electrochemical performance thereof.

The mixture may then be sintered in an inert atmosphere, such as an argon atmosphere, in order to form active material particles including the CSS coating on the silicon oxide material core particles. For example, depending on the G13/G15 material precursor, the mixture may be sintered at a temperature of about 1200° C. or less, such as a temperature ranging from about 300° C. to about 1200° C., from about 300° C. to about 750° C., or from about 300° C. to about 700° C., or from about 300° C. to about 650° C., or from about 800° C. to about 1200° C., or from about 800° C. to about 1100° C., or from about 800° C. to about 1000° C. for a time period ranging from about 1 to about 20 hours, such as from about 3 to about 7 hours, or from about 4 to about 6 hours. The CSS 110 may include the G13/G15 material precursors and/or may include G13/G15 materials formed by reacting the G13/G15 precursor materials with the core particles 102.

In some embodiments, temperatures of up to about 900° C. may be used during the annealing process. However, the present inventors discovered that sintering at temperatures above about 800° C., such as above about 750° C., or above about 700° C., may result in the formation of an increased amount unstable amount of unstable residues having a high alkalinity and/or may increase the grain size of silicon, silicon oxide, and lithium silicate phases, which may lead to a higher chance of particle fracture. As such, a G13/G15 material coating may not be properly formed on the surface of the core particles, and the presently described benefits may not be provided in full.

FIG. 1B is a sectional diagram showing an active material particle 100A, according to various embodiments of the present disclosure. The active material particle 100A may be similar to the active material particle 100. As such, only the difference there between will be discussed in detail.

Referring to FIG. 1B, the active material particle 100A may include the core particle 102 and the CSS 110 disposed thereon. The active material particle 100A may also include a carbon layer 112 disposed between the CSS 110 and the core particle 102. The carbon layer 112 may be formed of a carbon material, such as activated carbon, carbon black, a graphene material, or the like. The active material particle 100A may be formed using the same method as the active material particle 100 of FIG. 1A, except that the carbon layer 112 may be formed on the core particle 102 first using any suitable carbon layer coating method, followed by forming the CSS 110 on the carbon layer 112.

Composite Particles

FIG. 1C is a sectional diagram showing an active material encapsulated particle 120, according to various embodiments of the present disclosure. Referring to FIG. 1C, the encapsulated particle 120 may include the active material particles 100 or the active material particle 100A, encapsulated in a graphene material shell 122. The shell 122 may include a flexible, highly-conductive graphene material, such as graphene, graphene oxide, partially reduced graphene oxide, or combinations thereof. In some embodiments, the encapsulated particles 120 may additionally include carbon nanotubes (not shown) disposed on or in the shell 122.

In various embodiments, the shell 122 may completely encapsulate the active material particle 100/100A, as shown in FIG. 1C. However, in some embodiments, the shell 122 may partially encapsulate the active material particle 100/100A. In some embodiments, the shell 122 may represent from about 0.5 wt % to about 20 wt %, such as from about 1 wt % to about 10 wt %, or from about 2 wt % to about 5 wt %, of the total weight of the encapsulated particles 120.

The shell 122 may ensure that the active material particle 100/100A is uniformly cycled (movement of electrons and Li-ions in and out of the structure) in all three dimensions, due to its conductive nature, thereby minimizing the stresses exerted on and by the core particle 102 and minimizing particle fracture. Additionally, in the event that the active material particle 100/100A does fracture, the flexible shell 122 may operate to electrically connect the fractured silicon oxide material of the active material particle 100/100A and maintain the overall integrity of the encapsulated particles 120, thereby leading to significantly improved electrochemical performance.

In various embodiments, encapsulated particles 120 may comprise or consist of, based on the total weight of the encapsulated particles 120, from about 90 to about 99 wt % active material, such as the SiO material or the M-SiO material, from about 0.1 wt % to about 5 wt %, such as from about 0.5 wt % to about 3 wt %, of the G13/G15 material, from 0 to about 5 wt %, such as from 0.5 wt % to about 3 wt % carbon material, from about 2 wt % to about 5 wt % of the graphene material, and from 0 to about 0.3 wt % carbon nanotubes or other conductive additive. In some embodiments, the encapsulated particles 120 may comprises from about 0.5 to about 1.5 wt %, such as from about 0.75 wt % to about 1.25 wt % of the G13/G15 material.

FIG. 1D is a sectional diagram showing an encapsulated particle 130, according to various embodiments of the present disclosure. Referring to FIG. 1D, the encapsulated particle 130 may include the core particle 102 and the CSS 110 disposed thereon, as described above with respect to FIG. 1A. The encapsulated particle 130 may also include a carbon layer 113 disposed on the CSS 110. The carbon layer 113 may be formed of a carbon material, such as activated carbon, carbon black, a graphene material, a pyrolyzed carbon material, or the like.

In some embodiments, the carbon layer 113 may be formed by coating the CSS 110 coated core particle 102 with the carbon material using any suitable coating method, such as mechanofusion, spheronization, low-shear mixing, chemical vapor deposition, or the like. In other embodiments, the carbon layer 113 may be formed by coating the CSS 110 coated core particle 102 with a carbonaceous precursor material comprising: hydrocarbons such as pitch or tar; citric acid; polysaccharides such as sucrose, glucose, or chitosan; polymers such as polyvinyl alcohol (PVA), polyvinylpyrrolidone (PVP), polyacrylic acid (PAA), polydopamine (PDA), or polyacrylonitrile (PAN); combinations thereof; or the like, using any suitable coating method, such as spray drying, aerosol coating, droplet evaporation, or the like. A pyrolysis step may then be performed to pyrolyze the precursor material and form the carbon layer 113. In some embodiments, the precursor material may be applied by spray pyrolysis to directly form the carbon layer 113, and a separate pyrolysis step may be omitted.

Core Particles

FIG. 1E is a sectional diagram of a core particle 102A, according to various embodiments of the present disclosure. Referring to FIG. 1E, the core particle 102A may include heterogeneous silicon-containing phases 104, 106, 108. For example, the silicon-containing phases 104, 106, 108 may independently comprise crystalline and/or amorphous silicon, silicon oxide (e.g., SiOₓ, wherein x ranges from 0.8 to 1.2, such as from 0.9 to 1.1), and/or lithiated silicon species. However, in some embodiments the core particle 102A material may be substantially homogeneous and may lack distinct phases, but includes silicon, oxygen and optionally Li and/or Mg.

FIG. 1F is a sectional diagram of an active material core particle 102B, according to various embodiments of the present disclosure. Referring to FIG. 1F, the core particle 102B may include a primary phase 103, in which crystalline silicon domains 105 are dispersed as a secondary phase. For example, the primary phase 103 may include lithiated silicon species such as lithium silicate species, and in particular, Li₂SiO₃, Li₄SiO₄, and Li₂Si₂O₅. In other embodiments, the primary phase 103 may comprise magnesium-metalized silicon species, magnesium silicate species, and in particular MgSiO₃, Mg₂SiO₄, or combination thereof. The crystalline silicon domains 105 may comprise crystalline silicon nanoparticles having a particle size of less than 100 nm. For example, the crystalline silicon domains 105 may have an average particle size ranging from about 3 nm to about 60 nm. In one embodiment, a majority of the crystalline silicon domains 105 may have an average particle size ranging from about 5 nm to about 10 nm, and a remainder of the crystalline silicon domains 105 may have an average particle size from about 10 nm to about 50 nm.

In some embodiments, the core particle 102B may optionally include SiOₓ domains 107 (e.g., SiOₓ, wherein x ranges from 0.8 to 1.2, such as from 0.9 to 1.1) dispersed in the primary phase 103 as secondary phases. The SiOₓ domains 107 may have a particle size of less than about 100 nm. For example, the SiOₓ domains 107 may have an average particle size ranging from about 3 nm to about 60 nm, such as from about 5 nm to about 50 nm.

Referring to FIGS. 1A-F, the core particles 102A, 102B may utilized as the core particles 102 discussed above. In various embodiments, the core particles 102 may represent from about 80 wt % to about 99.5 wt %, such as from about 90 wt % to about 99 wt %, including about 90 wt % to 95 wt % of the total weight of the composite particles 100. In some embodiments the M-SiO material may include from about 40 at % to about 5 at %, such as from 20 at % to about 10 at %, or about 15 at % of lithiated silicon species. In some embodiments the M-SiO material of the core particles 102A may include from about 60 at % to about 95 at %, such as from about 80 at % to about 90 at %, or about 85 at % silicon and SiOₓ. The M-SiO material of the core particles 102 may have a silicon to oxygen atomic weight ratio ranging from about 1.25:1 to about 1:1.25, such as from about 1.1:1 to about 1:1.1, or of about 1:1. In some embodiments, the M-SiO material of the core particles 102 may comprise approximately equal atomic amounts of crystalline silicon and SiOₓ.

During an initial charging reaction and/or subsequent charging reactions, the composition of the M-SiO material of the core particles 102A may change due to lithiation and/or other reactions. For example, Si and SiOₓ may be lithiated to form LiₓSi domains. In addition, some SiOₓ may form inactive species, such as lithium silicates and Li₂O.

Turbostratic Carbon

In various embodiments, the shell 122 may preferably comprise a flexible, highly conductive graphene material having low-defect turbostratic characteristics, which may be referred to as turbostratic carbon. The low-defect turbostratic carbon may be in the form of platelets comprising from one to about 10 layers of a graphene material, such as graphene, graphene oxide, or reduced graphene oxide. In some embodiments, the low-defect turbostratic carbon may comprise at least 90 wt %, such as from about 90 wt % to about 100 wt % graphene. The graphene material may further comprise a powder, particles, mono-layer sheets, multi-layer sheets, flakes, platelets, ribbons, quantum dots, tubes, fullerenes (hollow graphenic spheres) or combinations thereof.

The turbostratic carbon may be in the form of sheets or platelets that partially overlap to simulate larger size single sheet structures. In some embodiments the platelets have more than one or more layers of a graphene-based material. In some embodiments, the platelets may have sheet size may be on average ≤15 μm. In some embodiments, the platelets may have sheet size may be on average ≤1 μm. In some embodiments, the turbostratic carbon-based material platelets may have low thickness. In some embodiments, a low thickness of the turbostratic carbon-based material platelets may be on average ≤1 μm. In some embodiments, a low thickness of the turbostratic carbon-based material platelets may be on average ≤100 nm.

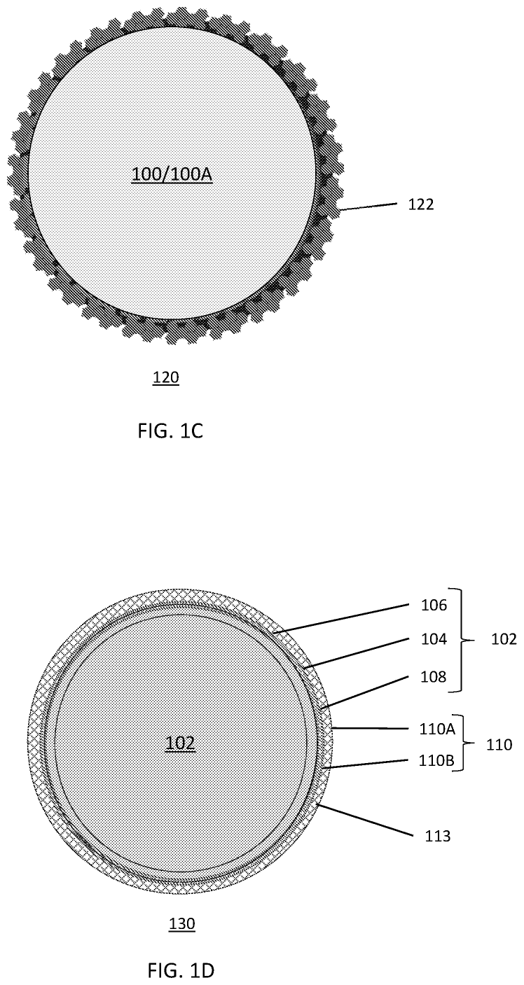

FIGS. 2A, 2B and 2C illustrate Raman spectra for graphite and various graphene-based materials. It has been well established that graphite and graphene materials have characteristic peaks at approximately 1340 cm⁻¹, 1584 cm⁻¹ and 2700 cm⁻¹. The peak at 1340 cm⁻¹ is shown in FIG. 2C, and is characterized as the D band. The peak at 1584 cm⁻¹ is shown in the spectra of FIGS. 2A and 2C, and is characterized as the G band, which results from the vibrational mode represented by the C═C bond stretching of all pairs of sp² hybridized carbon atoms. The D band originates from a hybridized vibrational mode associated with graphene edges and it indicates the presence of defects or broken symmetry in the graphene structure. The peak at 2700 cm⁻¹ is shown in FIG. 2B, and is characterized as the 2D band, which results from a double resonance process due to interactions between stacked graphene layers. The emergence of a double peak at the 2D wavenumber breaks the symmetry of the peak, and is indicative of AB stacking order between graphene planes in graphite and graphite derivatives such as nanoplatelets. The 2D₁ peak shown in FIG. 1B becomes suppressed when the AB stacking order in turbostratic multilayer graphene particles is disrupted. The positions of the G and 2D bands are used to determine the number of layers in a material system. Hence, Raman spectroscopy provides the scientific clarity and definition for electrochemical cell carbon material additives, providing a fingerprint for correct selection as additives for active material electrode compositions. As will be shown, the present definition provides that fingerprint for the low-defect turbostratic carbon of the present application. It is this low-defect turbostratic carbon when used as an additive to an electrochemical cell electrode active material mixture that provides superior electrochemical cell performance.

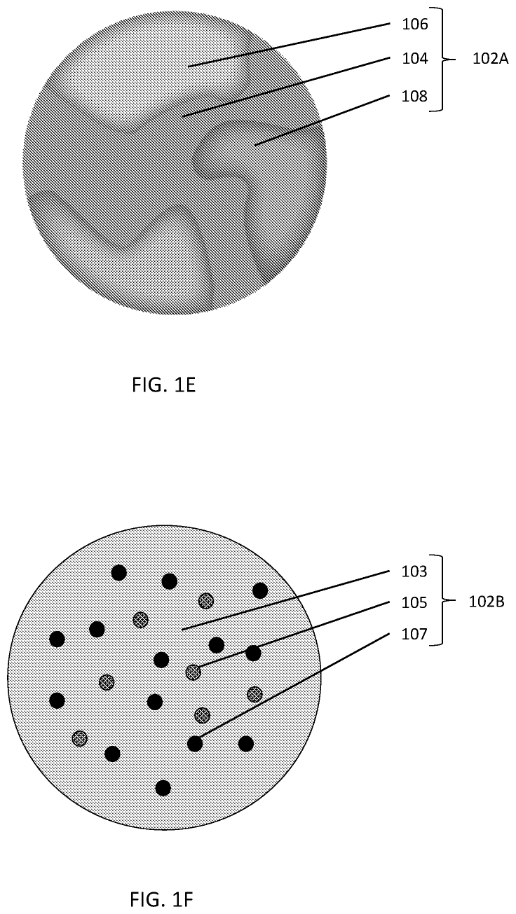

FIG. 3 provides the I_{D}/I_{G} ratio of carbon additives typically used in prior art electrode active material mixtures (i.e., reduced graphene oxide or amorphous carbon) compared with the low-defect turbostratic carbon of the present application.

Reduced graphene oxide (rGO) is a carbon variant that is often referred to as graphene in the industry, however, is unique in final structure and manufacturing process. Graphene oxide is typically manufactured first using a modified Hummers method wherein a graphite material is oxidized and exfoliated into single layers or platelets comprising a few layers of carbon that may comprise various functional groups, including, but not limited to, hydroxyls, epoxides, carbonyls, and carboxyls. These functional groups are then removed through chemical or thermal treatments that convert the insulating graphene oxide into conductive reduced graphene oxide. The reduced graphene oxide is similar to graphene in that it consists of single layers of carbon atom lattices, but differs in that it has mixed sp2 and sp3 hybridization, residual functional groups and often increased defect density resultant from the manufacturing and reduction processes. Reduced graphene oxide is shown in the first bar of FIG. 3 and has an I_{D}/I_{G} ratio of 0.9.

Amorphous carbon is often used as an additive or surface coating for both electrochemical cell anode and cathode material mixtures to enhance electrode conductivity. Typically, amorphous carbons are produced using a chemical vapor deposition (CVD) process wherein a hydrocarbon feedstock gas is flowed into a sealed vessel and carbonized at elevated temperatures onto the surface of a desired powder material. This thermal decomposition process can provide thin amorphous carbon coatings, on the order of a few nanometers thick, which lack any sp2 hybridization as found in crystalline graphene-based materials. Amorphous carbon is shown in the third bar of FIG. 3 and has an I_{D}/I_{G} ratio >1.2.

Low-defect turbostratic carbon, also referred to as graphene, comprises unique characteristics resultant from its manufacturing processing. One common method of producing this material is through a plasma based CVD process wherein a hydrocarbon feedstock gas is fed through an inert gas plasma in the presence of a catalyst that can nucleate graphene-like carbon structures. By controlling the production parameters, carbon materials having a few layers and absent any AB stacking order between lattices can be produced. These carbon materials are typically highly ordered sp2 carbon lattices with low-defect density.

The low-defect turbostratic carbon of the present disclosure is shown in the center second bar of FIG. 3. The Raman spectrum of the low-defect turbostratic carbon additive of the present application is derived from the intensity ratio of the D band and the G band (I_{D}/I_{G}) and the intensity ratio of the 2D band and the G band (I_{2D}/I_{G}). The I_{D}, I_{2D}, and I_{G} are represented by their respective integrated intensities. A low I_{D}/I_{G} ratio indicates a low-defect material. The low-defect turbostratic carbon material of the present invention has an I_{D}/I_{G} ratio of greater than zero and less than or equal to about 0.8, as determined by Raman spectroscopy with I_{G} at wavenumber in a range between 1580 and 1600 cm⁻¹, I_{D} at wavenumber in a range between 1330 and 1360 cm⁻¹, and being measured using an incident laser wavelength of 532 nm. Additionally, the low-defect turbostratic carbon material of the present disclosure exhibits an I_{2D}/I_{G} ratio of about 0.4 or more. As reference regarding the I_{2D}/I_{G} ratio, an I_{2D}/I_{G} ratio of approximately 2 is typically associated with single layer graphene. I_{2D}/I_{G} ratios of less than about 0.4 is usually associated with bulk graphite consisting of a multitude of AB stacked graphene layers. Hence, the I_{2D}/I_{G} ratio of about 0.4 or more, for the low-defect turbostratic carbon material of the present disclosure, indicates a low layer count of ≤10. The low-defect turbostratic carbon material of low layer count further lacks an AB stacking order between graphene layers (i.e., turbostratic). The turbostratic nature or lack of AB stacking of these graphene planes is indicated by the symmetry of the I_{2D} peak. It is the symmetry of the 2D peak that distinguishes a turbostratic graphene layered material from an AB stacked graphene layered material, and is indicative of rotational stacking disorder versus a layered stacking order.

Carbon materials with high AB stacking order will still exhibit 2D peaks, however, these 2D peaks exhibit a doublet that breaks the symmetry of the peak. This break in symmetry is exhibited in both AB stacked graphene of a few layers or graphite of many layers. Thus, the 2D peak, which is a very strong indicator of the presence of stacking order regardless of the number of graphene layers present in the material, is of significance when selecting a graphene or graphene-based additive. It is the rotational disorder of the stacking in the low-defect turbostratic carbon of the present disclosure that distinguishes itself from all the other graphene or graphene-based additives used to date, as the rotational disorder of the low-defect turbostratic carbon stacking of the present application is what offers flexibility to the carbon-based particles of the present application, which therein enables the ability of these carbon-based particles to provide and preserve contact with the active core particle of the composite particles comprising the electrode of the electrochemical cell. The result is an electrochemical cell having increased cycle life, better cycle life stability, enhanced energy density, and superior high rate performance.

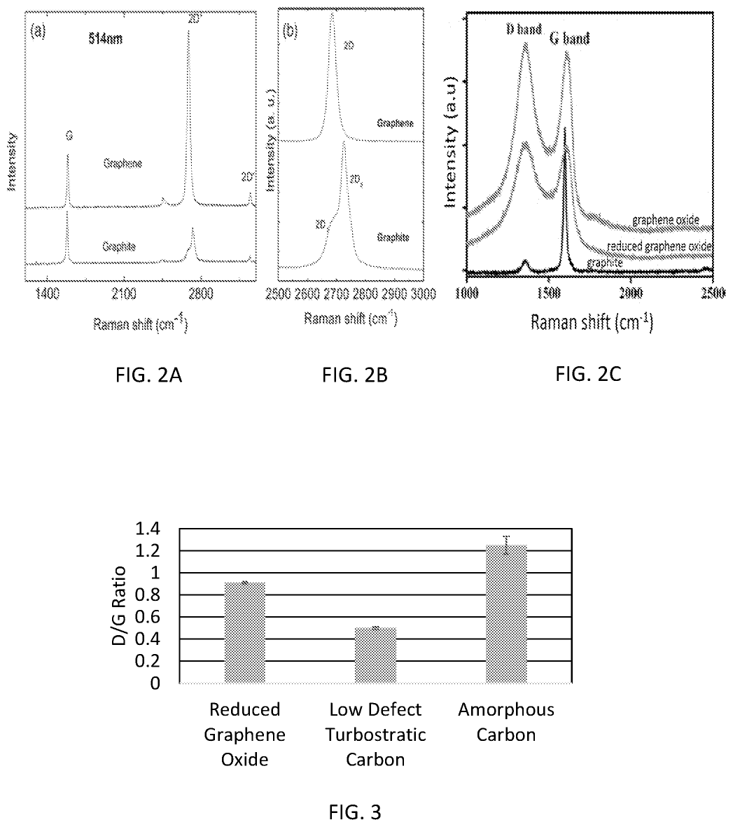

FIG. 4A is a graph of the Raman spectra for an active material mixture comprising SiO material particles coated with an amorphous carbon material. FIG. 4B is a graph of the Raman spectra for an active material mixture comprising SiO material core particles encapsulated by rGO. FIG. 4C is a graph showing the Raman spectra for an active material mixture comprising SiO material core particles encapsulated by a low-defect turbostratic carbon. Each spectra is different because of varying layer thickness (size, shape and position of 2D peak around wavelength 2700 cm⁻¹) and disorder (size of D peak around wavelength 1340 cm⁻¹).

Raman analysis sample preparation involved taking small aliquots of powders such as active material powders, composite material powders, carbon material powder, and placing these powders individually into a clean glass vial. The sample powder is rinsed with methanol. The powder/methanol solutions are then vortexed briefly and sonicated for approximately 10 minutes. The suspension is then transferred to a microscope slide with a micropipette. The slides are then allowed to air dry completely before conducting the analysis.

The Raman spectroscopy analysis of the present application is conducted using confocal Raman spectroscopy on a Bruker Senterra Raman System under the following test conditions: 532 nm laser, 0.02 mW, 50× objective lens, 90 second integration time, 3 co-additions (3 Raman spectroscopy sample runs) using a 50×1000 μm aperture and a 9-18 cm⁻¹ resolution. As a point of reference, the D band is not active in the Raman scattering of perfect crystals. The D band becomes Raman active in defective graphitic materials due to defect-induced double resonance Raman scattering processes involving the π-π electron transitions. The intensity of the D band relative to the G band increases with the amount of disorder. The intensity I_{D}/I_{G} ratio can thereby be used to characterize a graphene material.

The D and G bands of the amorphous carbon shown in FIG. 4A are both of higher intensity than either the reduced graphene oxide (rGO) D and G bands of FIG. 4B or the turbostratic carbon D and G bands of FIG. 4C. The amorphous carbon also exhibits a substantially higher I_{D}/I_{G} ratio (1.25) than do rGO and turbostratic carbon. The suppressed intensity of the amorphous carbon G band compared to that of its D band reflects the lack of crystallinity (also known as its graphitic nature) within its carbon structure. The D peak intensity being higher than the G peak intensity is caused by the high amount of defects in the amorphous carbon network. Hence, the amorphous carbon spectra exhibits low crystallinity and a much higher degree of disorder in its graphitic network compared with more crystalline carbons, such as graphene, graphene oxide, and rGO. Moreover, the higher intensity of the rGO D peak compared with its G peak, and its higher I_{D}/I_{G} ratio (almost 2×) compared to the turbostratic carbon D and G peak intensities and I_{D}/I_{G} ratio indicates the rGO to have more defects than the turbostratic carbon of the present application.

Table 1 below provides the detail for the Raman spectra of FIGS. 4A-4C.

TABLE 1

| | D | G | 2D | I_{D}/I_{G} | I_{2D}/I_{G} |
|---|---|---|---|---|---|
| rGO | | | | | |
| Cm⁻¹ | 1346.98 | 1597.82 | — | | |
| Intensity | 9115.5 | 10033.3 | — | .91 | — |
| Low Defect | | | | | |
| Turbostratic | | | | | |
| Carbon | | | | | |
| Cm⁻¹ | 1346.92 | 1581.32 | 2691.9 | | |
| Intensity | 2915.3 | 5849.98 | 6009.4 | 0.5 | 1.03 |
| Amorphous | | | | | |
| Carbon | | | | | |
| Cm⁻¹ | 1344.93 | 1589.40 | 2695.4 | | |
| Intensity | 6194.8 | 4908.2 | 5238.5 | 1.25 | 1.07 |

Careful inspection of these spectra show that when disorder increases, the D band broadens and the relative intensity of the band changes. For the amorphous carbon coated sample, the high intensity (6194.8) and broad D peak indicates a high amount of defects. The G peak being lower in intensity (4908.2) then the D peak (6194.8) indicates a lack of crystallinity. The D peak intensity (9115.5) and G peak intensity (10033.3) of the rGO encapsulated sample are fairly alike. Noticeable, however, is that the D peak intensity (9115.5) of the rGO sample is substantially higher than the D peak intensity (2915.3) of the turbostratic carbon sample indicating that the rGO sample has substantially higher defect density than does the turbostratic carbon sample. Also noticeable is that the G band for the amorphous carbon and the rGO samples are shifted to the right of wavelength 1584 cm⁻¹ to wavelength 1589.4 cm⁻¹ and 1597.82 cm⁻¹ respectively, whereas the G band for the turbostratic carbon sample lies slightly to the left of wavelength of 1584 cm⁻¹ at 1581.32 cm⁻¹. Of significance is that, unlike the amorphous carbon and the rGO samples, the turbostratic carbon (in this case, graphene sample) does not display much, if any, shift in position, reflecting low-defects therein, thus, the turbostratic carbon sample most nearly resembles an almost ‘perfect’ turbostratic carbon material.

Electrode Materials

Various embodiments of the present disclosure provide electrode materials for Li-ion batteries, and in particular, anode electrode compositions. The electrode material may include an active material as described above, a binder, and optionally single-wall carbon nanotubes (SWCNTs). The active material may include the above described active material particles 100 or 100A, or the encapsulated particles 120 (i.e., containing the active material particles 100 or 100A encapsulated in the shell 122) and optionally additional graphite particles. In some embodiments, the electrode materials may optionally include a conductive additive, such as carbon black. The active material and the graphite particles may be mixed with each other. The carbon black particles may be smaller (i.e., have a smaller diameter) than the silicon oxide particles and the graphite particles, and may be located between and/or on surfaces of the silicon oxide particles and/or the graphite particles. The SWCNTs may extend between the mixture of silicon oxide particles and the graphite particles and provide long range conductivity across multiple active particles.

The electrode materials may include an active material comprising SiO or M-SiO material core particles and a G13/G15 material coated on and boron and/or phosphorus optionally diffused into the core particles, as described above. Thus, the core particles may include silicon, metal silicate, and silicon oxide phases and optional lithiated silicon species, and a coating and/or diffusion layer including boron and/or phosphorus, described above. The active material particles may include the optional carbon coating, or the carbon coating may be omitted.

The active material may have an average particle size that ranges from about 1 μm to about 20 μm, such as from about 1 μm to about 15 μm, from about 3 μm to about 10 μm, or from about 5 μm to about 8 μm. The active material particles may have a surface area that ranges from about 0.5 m²/g to about 30 m²/g, such as from about 1 m²/g to about 20 m²/g, including from about 1.5 m²/g to about 15 m²/g.

The electrode materials may include at least 65 wt % of the active material, such as from about 70 wt % to about 98 wt %, from about 70 wt % to about 90 wt %, or about 75 wt % of the active material.

The electrode material may optionally include graphite particles. For example, the electrode material may include from about 0 wt % to about 97 wt %, such as from about 50 wt % to about 95 wt %, from about 5 wt % to about 35 wt %, from about 10 wt % to about 30 wt %, or from about 15 wt % to about 25 wt % graphite particles, and from about 3 wt % to about 100 wt %, such as from about 5 wt % to about 50 wt %, from about 95 wt % to about 65 wt %, 90 wt % to about 70 wt %, or from about 85 wt % to about 75 wt % of the active material particles. It should be noted that graphite may also act as an active material during battery operation. However, the active material particles are described herein separately from the graphite particles for clarity of description.

The graphite may include graphite particles of synthetic or natural origin. The graphite may have an average particle size ranging from about 2 μm to about 30 μm, such as from about 10 μm to about 20 μm, including from about 12 μm to about 18 μm. In one embodiment, the average particle size of the graphite particles may be larger than the average particle size of the silicon oxide active material particles 100. The graphite particles may have a surface area that ranges from about 0.5 m²/g to about 2.5 m²/g, such as from about 1 m²/g to about 2 m²/g. The graphite particles 130 may be larger than the silicon oxide particles.

The electrode material may include any suitable electrode material binder. For example, the electrode material may include a polymer binder such as polyvinylidene difluoride (PVDF), Na-carboxymethyl cellulose (CMC), styrene butadiene rubber (SBR), polyacrylic acid (PAA), lithium polyacrylate (LiPAA), a combination thereof, or the like. In some embodiments, the binder may include a combination of the CMC and the SBR, where the CMC has a molecular weight from 250 to 850 g/mol and a degree of substitution from 0.65 to 0.9.

In various embodiments, the electrode material may include from about 1 wt % to about 12 wt %, such as from about 2 wt % to about 10 wt %, or from about 2 to about 8 wt % of the binder. In some embodiments, the electrode material may include from about 95 wt % to about 98 wt % of the active material, from about 1 wt % to about 2 wt % conductive agent, and from about 2 wt % to about 4 wt % binder, which may include CMC and SBR.

In some embodiments, the SWCNTs may have an average length of greater than about 1 μm. For example, the SWCNTs may have an average length ranging from about 1 μm to about 500 μm, such as from about 1 μm to about 10 μm. The SWCNTs may have an average diameter ranging from about 0.5 nm to about 2.5 nm, such as from about 1 nm to about 2 nm.

The SWCNTs may have an I_{G}/I_{D} ratio or greater than about 5, such as greater than about 6 or greater than about 10, as determined by Raman spectroscopy, with I_{G} being associated with the Raman intensity at wavenumber 1580-1600 cm⁻¹, and I_{D} being associated with the Raman intensity at wavenumber 1330-1360 cm⁻¹, as measured using an incident laser wavelength of 633 nm.

In various embodiments, the electrode material may include from about 0 to about 1 wt %, such as from about 0.075 wt % to about 0.9 wt %, from about 0.08 wt % to about 0.25 wt %, or about 0.1 wt % SWCTNs.

The conductive additive may include carbon black (e.g., KETJENBLACK or Super-P carbon black), low defect turbostratic carbon, acetylene black, channel black, furnace black, lamp black, thermal black, or combinations thereof. The conductive additive may optionally include metal powder, fluorocarbon powder, aluminum powder, nickel powder; nickel flakes, conductive whiskers, zinc oxide whiskers, potassium titanate whiskers, conductive metal oxides, titanium oxide, conductive organic compounds, conductive polyphenylene derivatives, conductive polymers, or combinations thereof.

In various embodiments, the electrode material may include from 0 to about 10 wt %, such as from about 0.25 wt % to about 7 wt %, from about 2 wt % to about 7 wt %, or about 5 wt % conductive additive. In some embodiments, the conductive additive may preferably include carbon black.

Anode Formation

According to various embodiments, an anode may be formed using any suitable method known to one or skill in the art. For example, active material particles (e.g., SiO material and/or M-SiO material particles having a CSS described above) may be mixed with graphite particles to form an active material. In one embodiment, the active material may include less than 50 wt % silicon oxide and more than 50 wt % graphite. The active material may be mixed with the binder and the optional SWCNTs and/or conductive additives to form a solids component. In some embodiments, the silicon oxide particles may be encapsulated in a turbostratic carbon shell 122 using, for example, a spray drying process, prior to forming the active material. Alternatively, the shell 122 may be omitted.

The solids component may be mixed with a polar solvent such as water or N-Methyl pyrrolidone (NMP), at a solids loading between about 20-60 wt %, to form an electrode slurry. For example, the mixing may include using a planetary mixer and high shear dispersion blade, under vacuum.

The electrode slurry may then be coated onto a metal substrate, such as a copper or stainless steel substrate, at an appropriate mass loading to balance the lithium capacity of the anode with that of a selected cathode. Coating can be conducted using a variety of apparatus such as doctor blades, comma coaters, gravure coaters, and slot die coaters.

After coating, the slurry may be dried to form an anode. For example, the slurry may be dried under forced air, at a temperature ranging from room temperature to about 120° C. The dried slurry may be pressed to reduce the internal porosity, and the electrode may be cut to a desired geometry. Typical anode pressed densities can range from about 1.0 g/cc to about 1.7 g/cc depending on the composition of the electrode and the target application. Cathode pressed densities may range from about 2.7 to about 4.7 g/cc.

In some embodiments, the active material particles may be coated with turbostratic carbon prior to forming the active material. For example, a mixture of silicon oxide particles, turbostratic carbon and a solvent may be spray dried, to form a powder, and the powder may then be heat-treated in an inert atmosphere, such as argon gas, to carbonize any remaining surfactant or dispersant. In other embodiments, the silicon oxide particles may be coated with turbostratic carbon using a binder and a mechano-fusion process.

Electrochemical Cell Assembly

Construction of an electrochemical cell involves the pairing of a coated anode substrate and a coated cathode substrate that are electronically isolated from each other by a polymer and/or a ceramic electrically insulating separator. The electrode assembly is hermetically sealed in a housing, which may be of various structures, such as but not limited to a coin cell, a pouch cell, or a can cell, and contains a nonaqueous, ionically conductive electrolyte operatively associated with the anode and the cathode. The electrolyte is comprised of an inorganic salt dissolved in a nonaqueous solvent and more preferably an alkali metal salt dissolved in a mixture of low viscosity solvents including organic esters, ethers and dialkyl carbonates and high conductivity solvents including cyclic carbonates, cyclic esters and cyclic amides. A non-limiting example of an electrolyte may include a lithium hexafluorophosphate (LiPF₆) or lithium bis(fluorosulfonyl)imide (LiFSi) salt in an organic solvent comprising one of: ethylene carbonate (EC), diethyl carbonate (DEC), dimethyl carbonate (DMC), fluoroethylene carbonate (FEC) or combinations thereof.

Additional solvents useful with the embodiment of the present invention include dialkyl carbonates such as tetrahydrofuran (THF), methyl acetate (MA), diglyme, trigylme, tetragylme, 1,2-dimethoxyethane (DME), 1,2-diethoxyethane (DEE), 1-ethoxy, 2-methoxyethane (EME), ethyl methyl carbonate, methyl propyl carbonate, ethyl propyl carbonate, dipropyl carbonate, and combinations thereof. High permittivity solvents that may also be useful include cyclic carbonates, cyclic esters and cyclic amides such as propylene carbonate (PC), butylene carbonate, acetonitrile, dimethyl sulfoxide, dimethyl formamide, dimethyl acetamide, gamma-valerolactone, gamma-butyrolactone (GBL), N-methyl-2-pyrrolidone (NMP), and combinations thereof.

The electrolyte may also include one or more additives, such as vinylene carbonate (VC), 1,3-propane sulfone (PS), prop-1-ene-1,3-sultone (PES), Flouroethylene carbonate (FEC), and/or propylene carbonate (PC). The electrolyte serves as a medium for migration of lithium ions between the anode and the cathode during electrochemical reactions of the cell, particularly during discharge and re-charge of the cell. The electrochemical cell may also have positive and negative terminal and/or contact structures.

In some embodiments, the electrolyte may be a solid-state electrolyte including a Li—B silicate and/or Li-silicate.

### Experimental Examples

The following examples relate to anode formed using electrode materials of various embodiments of the present disclosure and comparative electrode materials, and are given by way of illustration and not by way of limitation. In the examples, % is percent by weight, g is gram, CE is coulombic efficiency, and mAh/g is capacity.

Exemplary Anode Active Material: 2.5 grams of boric acid powder is gently mixed with 97.5 grams of a Li—SiO material powder in a planetary-type mixer, for 10 minutes. The resulting mixture is subsequently heated in a furnace in Ar atmosphere, for 5 h to drive off residual water and sinter the mixture, to form an exemplary anode active material comprising Li—SiO material particles modified with a chemical stability structure (CSS).

Control Active Material: A Li—SiO anode powder without the CSS is used as a Control Active Material.

Exemplary Half Cells: 0.75 grams of the exemplary anode active material, 0.05 grams conductive agent (C65 carbon black), 0.20 grams of an aqueous binder (poly(acrylic acid) 10.1 wt %) are combined in a small mixing jar. The combined materials are then rigorously mixed in a planetary mixer for 30 minutes to form an anode slurry. The anode slurry is coated on a copper foil with at a loading of 3 mAh/cm2 and an electrode density of 1.4-1.5 g/cc. The coating is dried and calendared to a porosity of 40-45% and then cut to form anodes. The anodes are assembled into half-cells (excess counter electrode material=lithium metal) and 100 microliter of electrolyte (1.2M LiPF₆, EC:EMC=3:7 with 20 wt % FEC additive) is injected into the cells. The cells are electrochemically “formed” under C/20, C/10, C/5 charge-discharge cycles, to complete the exemplary half cells.

Comparative Half Cells: 0.75 grams of the control Li—SiO anode active material, 0.05 grams conductive agent (C65 carbon black), 0.20 grams of an aqueous binder (Li-poly(acrylic acid) 10.1 wt %) are combined in a small mixing jar. The combined materials are then rigorously mixed in a planetary-type mixer for 30 minutes to form an anode slurry. The anode slurry is coated on a copper foil with at a loading of 3 mAh/cm2 and an electrode density of 1.4-1.5 g/cc. The coating is dried and calendared to a porosity of 40-45% and then cut to form anodes. The anodes are assembled into half-cells (excess counter electrode material=lithium metal) and 100 uL of electrolyte (1.2M LiPF₆, EC:EMC=3:7 with 20 wt % FEC additive) is injected into the cells. The cells are electrochemically “formed” under C/20, C/10, C/5 charge-discharge cycles, to complete the comparative half cells.

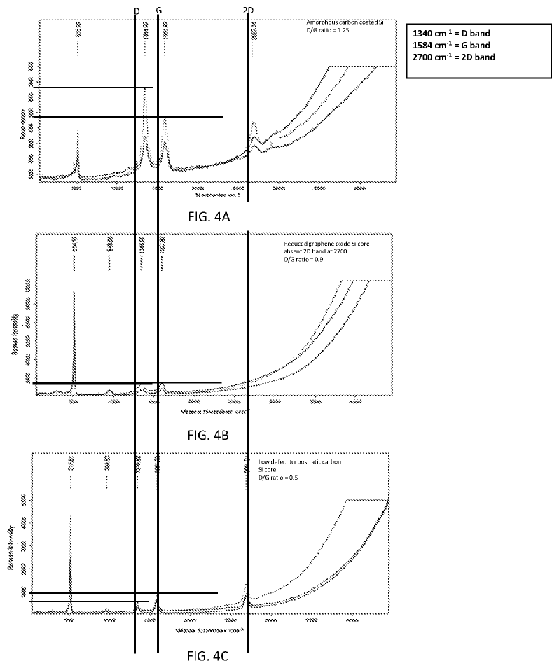

The exemplary and comparative half-cells are characterized under a standard C/2 charge-discharge protocol until the anode capacity of each cell was reduced to 80% of its initial capacity. The cycling performance of the cells is shown FIG. 5 and summarized in the following Table 2.

TABLE 2

| | 1^{st} Cycle | 1^{St} Cycle | | | | |
|---|---|---|---|---|---|---|
| | Charge | Discharge | | | Retention | |
| | Capacity | Capacity | 1^{st} Cycle | Capacity Retention (50^{th} | Improvement | |
| | (mAh/g) | (mAh/G) | Efficiency | cycle) | (50^{th} cycle) | pH |
| Exemplary | 1190 | 1049 | 88.2% | 74.3% | 640% | 9.58 |
| Half Cells | | | | | | |
| Control | 1240 | 1027 | 82.2% | 1.3% | — | 10.72 |
| Half Cells | | | | | | |

As shown in FIG. 5 and Table 2, the exemplary half cells including the surface modified Li—SiO active material have a higher first cycle efficiency and a 640% higher 50^{th} cycle capacity retention percentage than the comparative half cells.

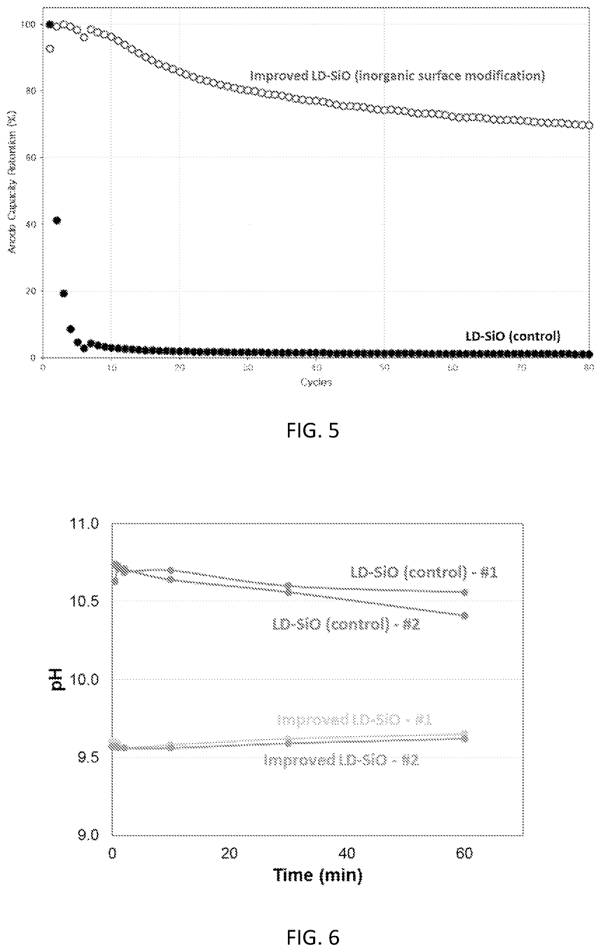

FIG. 6 is a chart showing the pH of exemplary and comparative active materials, over time, when dispersed in water. In particular, four mixtures are prepared including 0.5 g of exemplary or comparative active material dispersed in 25 g of DI water (2 wt % solids), at room temperature. The pH values of the mixtures are measured after 1, 2, 10, 30, and 60 minutes. Table 3 shows the results of the testing.

TABLE 3

| | pH at T₁ | pH at T₂ | % Δ 1 hr |
|---|---|---|---|
| Exemplary Active Material | 9.58 | 9.64 | +0.63% |
| Control Active Material | 10.72 | 10.49 | −2.19% |

As can be seen in FIG. 6 and Table 3, the exemplary active material had a significantly lower pH than the comparative active material, and exhibited significantly less pH change over time.

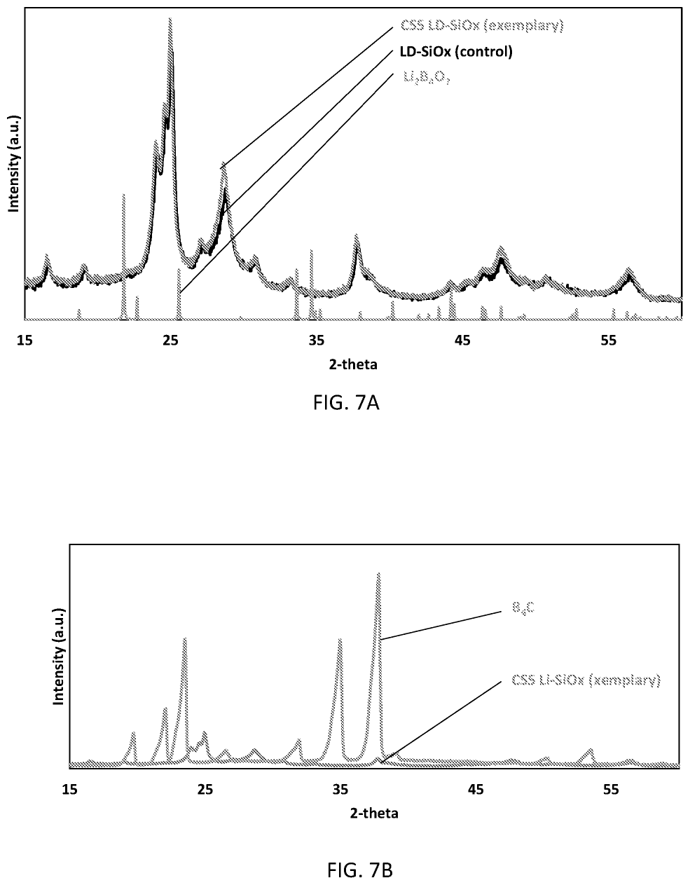

FIG. 7A is a graph showing X-ray diffraction (XRD) results for the exemplary active material, as compared to the control active material and crystalline Li₂B₄O₇. FIG. 7B is a graph showing XRD data for the exemplary active material and crystalline B₄C.

As can be seen in FIGS. 7A, the results indicate that the formation of the CSS in the exemplary active material resulted in a very slight change to particle crystallinity and structure. In addition, lithium tetraborate phases were not detected in either the exemplary or comparative active materials. As shown in FIG. 7B, the results did not indicate that boron carbide was present in the exemplary active material. Accordingly, the active material may include less than 0.5 at %, such as less than 0.1 at %, such as no carbide material.

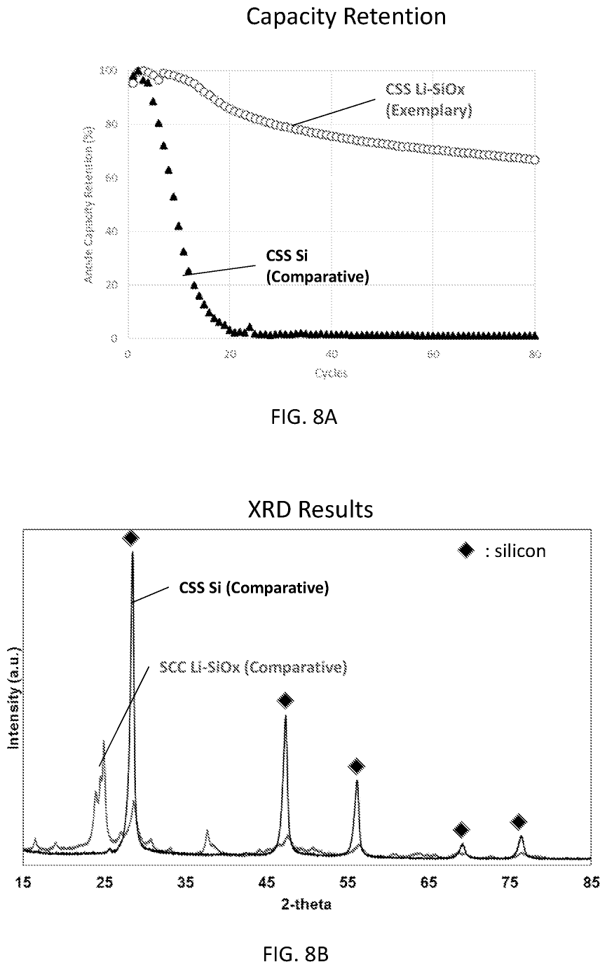

FIG. 8A is a graph showing capacity retention of half cells including anodes that included the exemplary active material, carbon black, and a PAA binder, at a 75:5:20 weight ratio, and comparative half cells that included anodes a comparative active material including Si nanoparticles and the CSS, carbon black, and a PAA binder, at a 75:5:20 weight ratio. FIG. 8B is a graph showing XRD results for the exemplary and comparative active materials.

As shown in FIG. 8A the exemplary half cells has a capacity retention of about 75% after 50 charge/discharge cycles. In contrast, the comparative half cells shows a rapid reduction in capacity, with 0 capacity retention after 25 charge/discharge cycles. Accordingly, it can be seen that the use of the silicon oxide nanoparticles and the CSS provides an unexpected improvement in capacity retention, as compared to the use of an active material including silicon nanoparticles and the CSS.

Referring to FIG. 8B, it can be seen that the exemplary active material includes substantially fewer silicon phases than the comparative active material. In addition, there is no evidence of borate formation in comparative active materials. As such, it can be concluded that the CSS layers of both the exemplary and comparative active materials are amorphous.

Accordingly, it is believed that the active material of the present embodiments includes an amorphous G13/G15 material that does not include a significant amount of crystallinity. While not wishing to be bound to any particular theory, the present inventors believe that coating active materials with crystalline G13/G15 material may impede lithium diffusion during charging and discharging of the active material. Impeded lithium diffusion may reduce fast charging and charging rate performance. In addition, impeded lithium diffusion may also increase the growth of internal resistance in the cells and increase cell operating temperatures, which may also increase the risk of cell explosion and may result in drastic cycle life degradation.

It is also believed that the diffusion of boron and/or phosphorus from the G13/G15 material into active material particles may unexpectedly provide for increased electrical conductivity, which may improve the charging rate performance of electrochemical cells.

Furthermore, by using prelithiated Li—SiO material core particles, removal of the native oxide from the core particles prior to lithiation is not required. Finally, the relatively high sintering temperature ranging from about 300° C. to about 800° C. is believed to localize majority of the G13/G15 material on the surface of the core particles and diffuses B and/or P into the surface regions of the core particles.

Although the foregoing refers to particular preferred embodiments, it will be understood that the invention is not so limited. It will occur to those of ordinary skill in the art that various modifications may be made to the disclosed embodiments and that such modifications are intended to be within the scope of the invention. All of the publications, patent applications and patents cited herein are incorporated herein by reference in their entirety.

What is claimed is:

1. An active material for a lithium ion secondary battery, comprising:
core particles comprising an SiO material or an M-SiOₓ material, wherein 0<x<1.2, and M is selected from Al, Ca, Cu, Fe, K, Li, Mg, Na, Ni, Sn, Ti, Zn, Zr, or any combination thereof; and
an amorphous Group 13 or Group 15 material (“G13/G15 material”) comprising at least one element selected from boron (B), aluminum (Al), gallium (Ga), indium (In), thallium (Tl), nitrogen (N), phosphorus (P), arsenic (As), antimony (Sb), or bismuth (Bi), coated on the core particles.

2. The active material of claim 1, wherein each active material particle further comprises a shell that encapsulates the core particle and comprises turbostratic carbon having a Raman spectrum having:
a D band having a peak intensity (I_{D}) at wave number between 1330 cm⁻¹ and 1360 cm⁻¹;
a G band having a peak intensity (I_{G}) at wave number between 1580 cm⁻¹ and 1600 cm⁻¹; and
a 2D band having a peak intensity (I_{2D}) at wave number between 2650 cm⁻¹ and 2750 cm⁻¹,
wherein:
a ratio of I_{D}/I_{G} ranges from greater than zero to about 1.1; and
a ratio of I_{2D}/I_{G} ranges from about 0.4 to about 2.

3. The active material of claim 1, further comprising a carbon layer disposed between the G13/G15 material and the core particles, the carbon layer comprising pyrolyzed carbon, activated carbon, or carbon black.

4. The active material of claim 3, wherein the G13/G15 material covers at least 60% of the surface of the core particles.

5. The active material of claim 1, wherein:
from about 0.1 atomic % to about 5 atomic % of the G13/G15 material is diffused into the core particles; and
from about 95 atomic % to about 99 atomic % of the G13/G15 material remains on the surfaces of core particles.

6. The active material of claim 1, wherein:
the G13/G15 material is at least 50 atomic % amorphous; and
the active material comprises less than 0.5 atomic % of a carbide material.

7. The active material of claim 6, wherein the G13/G15 material comprises a boron oxide, a borate, a borosilicate, a lithium borosilicate, a lithium phosphate, a silicate phosphate, a phosphorus oxide, a lithium silicate phosphate, or a combination thereof.

8. The active material of claim 1, wherein, based on the total weight of the active material, the active material comprises:
from about 90 wt % to about 99 wt % of the core particles;
from about 0.1 wt % to about 10 wt % of the G13/G15 material;
from 0 to about 5 wt % of a carbon material disposed between the G13/G15 material and the core particles;
from about 0 wt % to about 5 wt % of a graphene material encapsulating the core particles; and
from 0 to about 3 wt % of a conductive additive.

9. The active material of claim 8, wherein, based on the total weight of the active material, the active material comprises:
from about 0.1 wt % to about 5 wt % of the G13/G15 material; and
from about 95 wt % to about 99.9 wt % of the core particles.

10. The active material of claim 1, wherein:
the core particles have an average particle size ranging from about 500 nanometers to about 20 microns;
the G13/G15 material is coated at a thickness ranging from about 0.5 nm to about 500 nm.

11. The active material of claim 1, wherein:
the core particles comprise M-SiO;
M comprises Li; and
the M-SiO comprises at least one of crystalline or amorphous silicon domains, lithiated silicon species domains, and silicon oxide domains comprising SiO_{y}, where y ranges from 0.8 to 1.2.

12. The active material of claim 11, wherein:
the G13/G15 material comprises a boron oxide, a borate, a borosilicate, a lithium borosilicate, or a combination thereof; and
the M-SiO comprises lithiated silicon species domains comprising Li₂Si₂O₅, Li₂SiO₃, Li₄SiO₄, or a combination thereof.

13. The active material of claim 11, wherein:
the G13/G15 material comprises a lithium phosphate, a silicate phosphate, a phosphorus oxide, a lithium silicate phosphate, or a combination thereof; and
the M-SiO comprises lithiated silicon species domains comprising Li₂Si₂O₅, Li₂SiO₃, Li₄SiO₄, or a combination thereof.

14. The active material of claim 1, wherein: the core particles comprise at least one of crystalline or amorphous silicon domains, and silicon oxide domains comprising SiO_{y}, where y ranges from 0.8 to 1.2.

15. A lithium ion secondary battery, comprising:
an anode comprising an electrode material comprising the active material of claim 1 and a binder;
a separator;
a cathode; and
an electrolyte disposed between the anode and cathode.

16. The lithium ion secondary battery of claim 15, wherein the electrode material comprises, based on total weight of the active material:
from about 0.3 wt % to about 30 wt % of the binder;
from about 0.01 wt % to about 20 wt % of a conductive additive;
from about 0 wt % to about 97 wt % graphite particles; and
from about 3 wt % to about 100 wt % of the active material.

17. The lithium ion secondary battery of claim 15, wherein the active material comprises:
from about 50 wt % to about 95 wt % of the graphite particles; and
from about 5 wt % to about 50 wt % of the active material particles.

18. The lithium ion secondary battery of claim 15, wherein the binder comprises polyvinylidene difluoride (PVDF), Na-carboxymethyl cellulose (CMC), styrene butadiene rubber (SBR), polyacrylic acid (PAA), lithium polyacrylate (LiPAA), polyimide (PI), or a combination thereof.

19. The lithium ion secondary battery of claim 15, wherein the lithium ion battery is a solid state lithium battery comprising a solid-state anode, a solid state cathode, and a solid-state electrolyte.

20. A method of forming an active material for a lithium ion secondary battery, comprising:
mixing from about 1 wt % to about 10 wt % of precursor material comprising at least one of boron or phosphorus with from about 90 wt % to about 99 wt % of SiO or M-SiO material core particles, wherein M is selected from Al, Cu, Fe, K, Li, Mg, Na, Ni, Sn, Ti, Zn, Zr, or any combination thereof, to coat the core particles with the precursor material; and
sintering the coated core particles in an inert atmosphere to form active material particles comprising the core particles and an amorphous Group 13 or Group 15 material (“G13/G15 material”) comprising at least one element selected from boron (B), aluminum (Al), gallium (Ga), indium (In), thallium (Tl), nitrogen (N), phosphorus (P), arsenic (As), antimony (Sb), or bismuth (Bi), coated on the core particles.

21. The method of claim 20, wherein:
the mixing comprises using a low-shear mixing process; and
the G13/G15 material comprises a boron oxide, a borate, a borosilicate, a lithium borosilicate, a lithium phosphate, a silicate phosphate, a phosphorus oxide, a lithium silicate phosphate, or a combination thereof.

22. The method of claim 20, further comprising:
mixing the active material particles with a solvent and a carbon precursor material to form a mixture; and
evaporating the mixture to encapsulate the active material particles in a shell comprising the carbon based material,
wherein the sintering comprises pyrolyzing the carbon precursor material.

23. An active material for a lithium ion secondary battery, comprising:
core particles comprising an SiO material or an M-SiOx material, wherein 0<x<1.2, and M is selected from Al, Ca, Cu, Fe, K, Li, Mg, Na, Ni, Sn, Ti, Zn, Zr, or any combination thereof; and
an amorphous material comprising at least one of boron or phosphorus (“B/P material”) coated on the core particles.

24. The active material of claim 23, wherein the B/P material comprises a boron oxide, a borate, a borosilicate, a lithium borosilicate, a lithium phosphate, a silicate phosphate, a phosphorus oxide, a lithium silicate phosphate, or a combination thereof.
